(19) United States
(12) Patent Application Publication
(10) Pub. No.: US 2024/0403635 A1
(43) Pub. Date: Dec. 5, 2024

(54) METHOD FOR ADAPTIVE DISTRIBUTION OF CNNS ON HETEROGENEOUS DEVICES USING PARALLELIZATION

(71) Applicant: INTERDIGITAL CE PATENT HOLDINGS, SAS, Paris (FR)

(72) Inventors: Anne LAMBERT, Saint-Aubin-d’Aubigné (FR); Alexey OZEROV, Rennes (FR); Patrick FONTAINE, Rennes (FR)

(21) Appl. No.: 18/691,231

(22) PCT Filed: Sep. 8, 2022
(86) PCT No.: PCT/EP2022/075043

§ 371 Date: Mar. 12, 2024

(30) Foreign Application Priority Data
Sep. 23, 2021 (EP) 21306316.7

(51) Int. Cl. G06N 3/08

(52) U.S. Cl. CPC G06N 3/08

(57) ABSTRACT

A method or apparatus that combines properties of parallel distribution and flexibility of distribution of convolutional neural networks on heterogeneous devices uses parallelization for distributed inference of Deep Neural Networks. The method addresses parallel distribution among various numbers of devices of various capacities. A network is distributed in parallel for each configuration and is adaptive to different network capabilities.

### TECHNICAL FIELD

At least one of the present embodiments generally relates to a method or an apparatus for adaptive distribution of convolutional neural networks.

### BACKGROUND

Convolutional Neural Networks (CNNs) have allowed considerable progress in the processing of image, video, and time series signals. Their benefits in these fields have sparked an interest in generalizing their application to any types of devices.

### SUMMARY

At least one of the present embodiments generally relates to a method or an apparatus for adaptive distribution of CNNs on heterogeneous devices using parallelization.

According to a first aspect, there is provided a method. The method comprises steps for determining availability and capabilities of at least one device; determining whether a modification is available in the at least one device or in capabilities of the at least one device, and if a modification is available, determining and sending an updated network configuration; sending input of parallel sub-networks to the at least one device; executing sub-networks in the at least one device according to a received configuration; and, receiving output by the at least one device to a controller to execute fusion.

According to another aspect, there is provided an apparatus. The apparatus comprises a processor. The processor can be configured to implement the general aspects by executing any of the described methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates an AlexNet architecture for image classification, where “Conv” means a convolutional layer, “Pool” a max pooling layer, “FC a fully connected layer, and “Softmax” a soft maximum function.

FIG. 2 illustrates an AlexNet architecture split sequentially between two devices.

FIG. 3 illustrates an AlexNet architecture split parallelly between two devices.

FIG. 4 illustrates a “dummy” width-wise split of a fully connected (FC) layer. Many connections are lost after split.

FIG. 5 illustrates an example of possible widths of slimmable neural network.

FIG. 6 illustrates one embodiment of possible configurations of ParaDiS neural network under the present principles.

FIG. 7 illustrates an example flowchart of the deployment/inference scenarios.

FIG. 8 illustrates an example of communication flowchart for 2 devices.

FIG. 9 illustrates an example of ParaDis network training.

FIG. 10 illustrates one embodiment of a method under the general aspects.

FIG. 11 illustrates one embodiment of an apparatus under the general aspects.

FIG. 12 illustrates a generic video compression system.

FIG. 13 illustrates a generic video decompression system.

FIG. 14 illustrates a processor based system for implementing the general aspects described.

### DETAILED DESCRIPTION

The context of the described embodiments is the distributed inference of Deep Neural Networks (DNN) and more precisely of Convolutional Neural Networks (CNN). CNNs are widely used in different types of computer vision tasks such as image recognition (object, face . . . ) but have proven useful also in other domains such as speech processing for example.

By distributed inference we mean the execution of a DNN by several devices (end-user devices, edge/cloud server . . . ). This can be useful when the device is unable to handle the inference of the complete DNN because it lacks the computational resources for example.

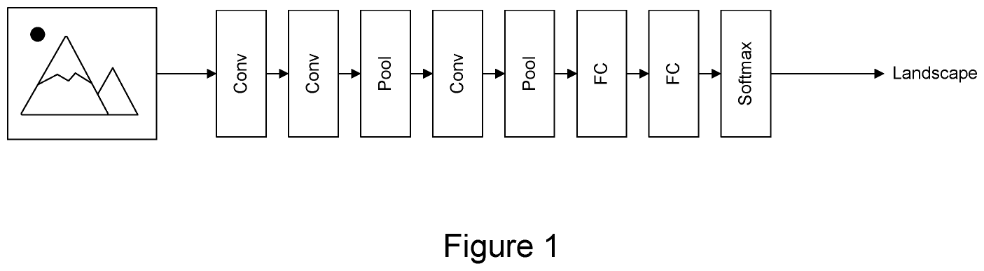

Let us consider as an example a simple CNN architecture for image classification as shown in FIG. 1.

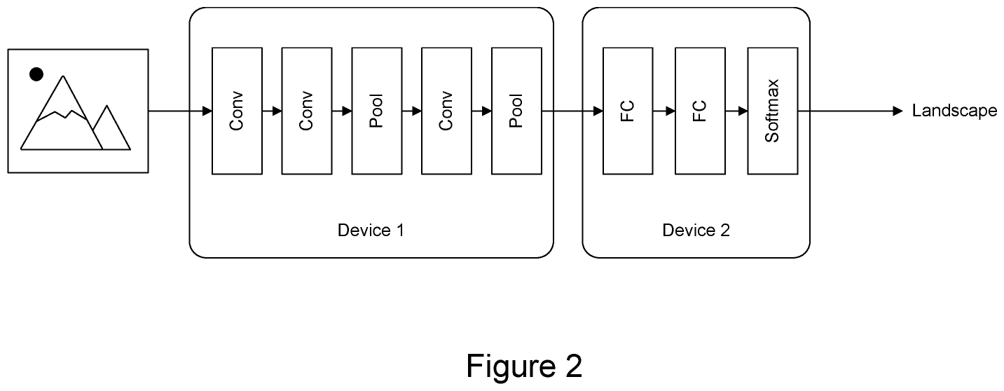

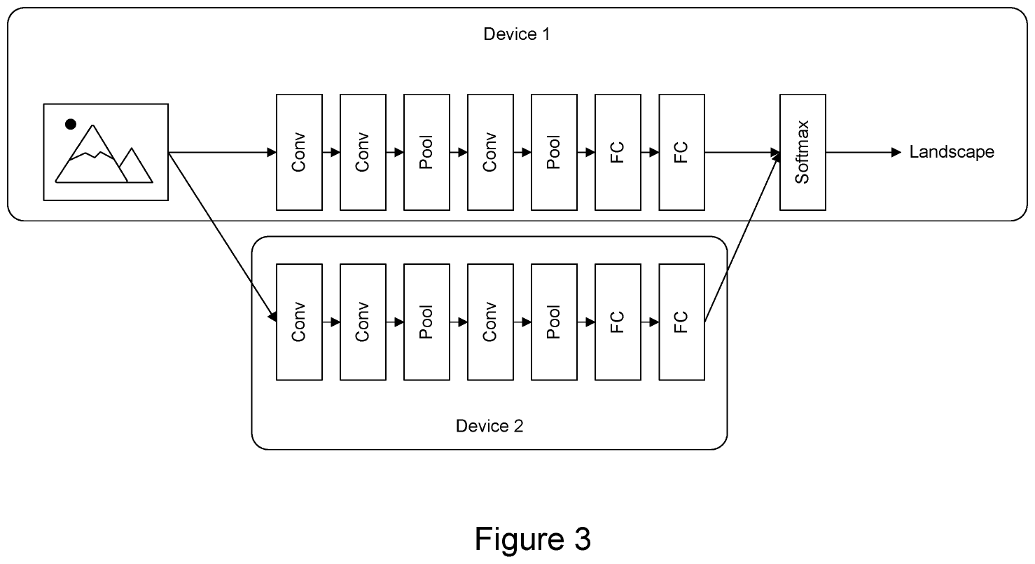

One of the most popular and simplest approaches to distribute a DNN on several devices is a sequential or depth-wise split. In this case a device receives an input, for example an image, and starts executing the first part of a complex DNN. Since it lacks the computational resources to perform the complete inference it transmits the intermediate data (intermediate features) to another device or to an edge/cloud server. An example of sequential inference in AlexNet architecture is illustrated in FIG. 2. As one may easily understand, the inference latency for a given input is the sum of the latency of all the devices and the intermediate features transmission time.

Where the previous example split the CNN depth-wise, we are interested in width-wise split where the layers are split and are executed on separate devices in parallel as shown in FIG. 3. By parallel, we also mean no intermediate data transmission.

Note that the latency of such processing is equal to the maximum of processing times in each device (plus communication time). As such, the processing latency is much smaller than that of the sequential split (recall that for sequential split the latency equals to the sum of processing times), assuming the same total amount of computations in both cases.

To resume parallel split (see FIG. 3) is much more efficient in terms of processing latency, as compared to sequential split (see FIG. 2). Parallel split is also more efficient in terms of communication, i.e., data transmission. Indeed, in most modern CNNs the intermediate CNN features needed to be transmitted in case of sequential split (see FIG. 2) are often bigger than the original data and the result needed to be transmitted in case of parallel split (see FIG. 3). On the other hand, while sequential split is easy (it is sufficient just to distribute a CNN between two devices), parallel split is more complicated to implement. It is not enough to just cut an existing network width-wise: to obtain a reasonable performance, the resulting parallel split must be either trained again from scratch or at least fine-tuned.

To overcome the last issue, in the described embodiments we propose a new framework where it is possible to parallelly split a CNN among several devices (of varying capacities) without any need of retraining or fine-tuning.

Many existing approaches for distributing the inference between several devices rely on sequential split strategies FIG. 2). However, as already mentioned, those strategies are far from being efficient. The total latency of the system is equal to the sum of the latency of each device and the sum of the transmission time for the data sent between devices)).

In contrast for parallel networks (FIG. 3) the total latency is equal to the maximum latency of the devices and the transmission of the input/output of the parallel network (which is generally smaller than the intermediate data transmitted for sequentially split networks).

There exist many strategies for designing parallel efficient networks that can run on several devices. Those networks might be either trained from scratch, or simply trained independently (though starting from different initializations) to form a network ensemble, they might be distilled from one bigger teacher network or an ensemble of bigger teacher networks via knowledge distillation. These different methods build parallel networks but have the disadvantage that their architecture is fixed. This means that they cannot be configured easily for different topology of devices: number of devices available and computational resources offered by each of them.

On the other hand, several recent approaches propose CNNs with a possibility for an instant adaptation to the available resources (e.g., computation, memory), or, in other words, with an instant tradeoff between model complexity and performance. We call those models flexible in the described embodiments. This flexibility is usually achieved via jointly training several models of varying characteristics that share between them most of their parameters. Those varying characteristics may include possible early exits in the same network, varying level of weights quantization, varying network width, or width, depth, and kernel size varying altogether. However, these approaches concern only models running on one device during inference.

In the described embodiments we propose a method, that would combine both properties of parallel distribution and flexibility of this distribution. In other words, we would like to address parallel distribution in various device settings (i.e., various numbers of devices of various capacities). However, instead of training a particular distributed network for each configuration, we would like the same network being parallelly distributable for each given configuration, and this is what we mean by flexibility here.

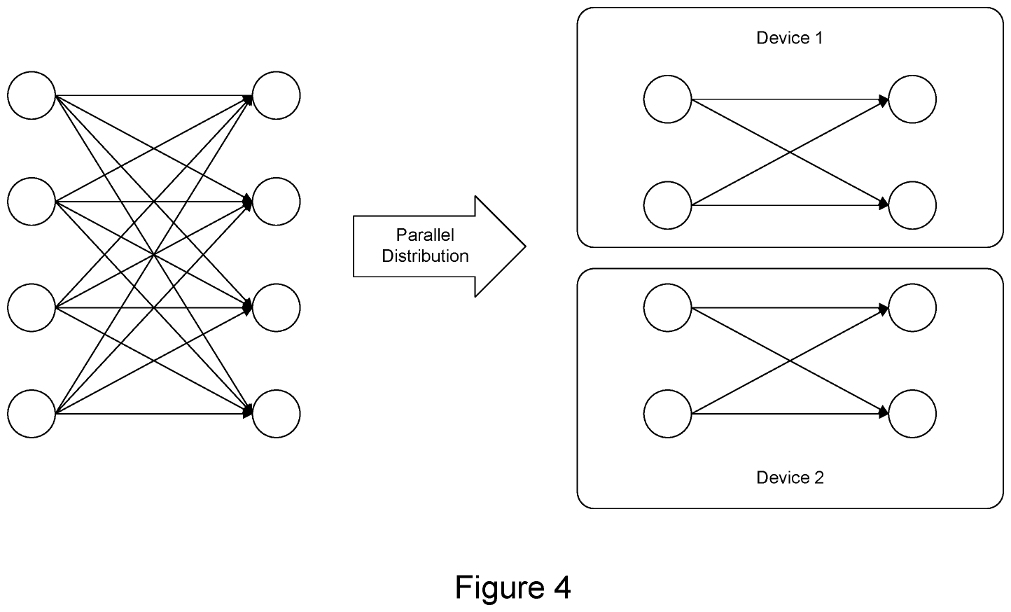

Let us recall again that a width-wise split of a network (i.e., going from FIG. 1 to FIG. 3) is not trivial in the sense that, once split, the network needs to be re-trained or fine-tuned. Indeed, there are a lot of inter-dependencies or connections between the channels of convolutional layers or the hidden units of the fully connected (FC) layers. If a convolutional or a FC layer is split width-wise, those connections are simply dropped (see FIG. 4). That means that the entire architecture has changed and, consequently, a re-training of fine-tuning is needed.

In the context of distributed inference, we are interested in an efficient deployment method for neural networks models that is parallelizable, flexible and with as little data transmitted between devices as possible.
Parallelization since it provides the lowest processing latency, as compared to other distribution schemes.
Flexibility because the deployment setting (characterized by number of devices and their capacities) is not known and may vary during deployment. It is therefore necessary to consider many different distributed configurations.
Limited transmission of data is the natural result of a parallel and flexible deployment: the parallelization limits the communication to the input and output of the parallel part of the network and the flexibility ensures that it is not necessary to download a new model when the device capacity changes.

To summarize, our problem consists in building a single CNN model that is flexible in the sense that it is parallelly distributable on several possible devices with different settings. The single CNN model needs to adapt to different settings without re-training of the parameters.

We introduce a so-called ParaDiS—Parallelly Distributable Slimmable framework. As its name indicates, this framework relies on the slimmable neural networks idea, but extends it to various parallelly distributable configurations.

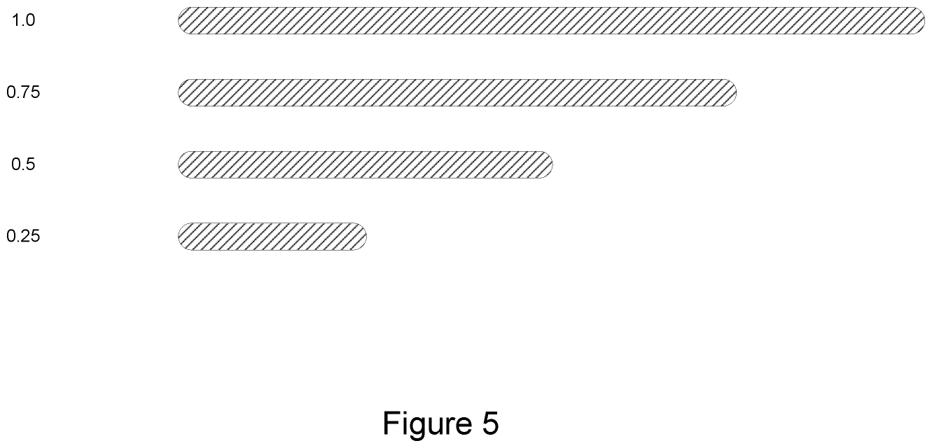

The idea behind slimmable neural networks framework consists in the possibility of slimming network width to a pre-defined set of widths thus providing a trade-off between the network complexity and performance. For example, as it is represented in FIG. 5, the full network of width 1.0 may be slimmed to a width of 0.75, of 0.5, or of 0.25.

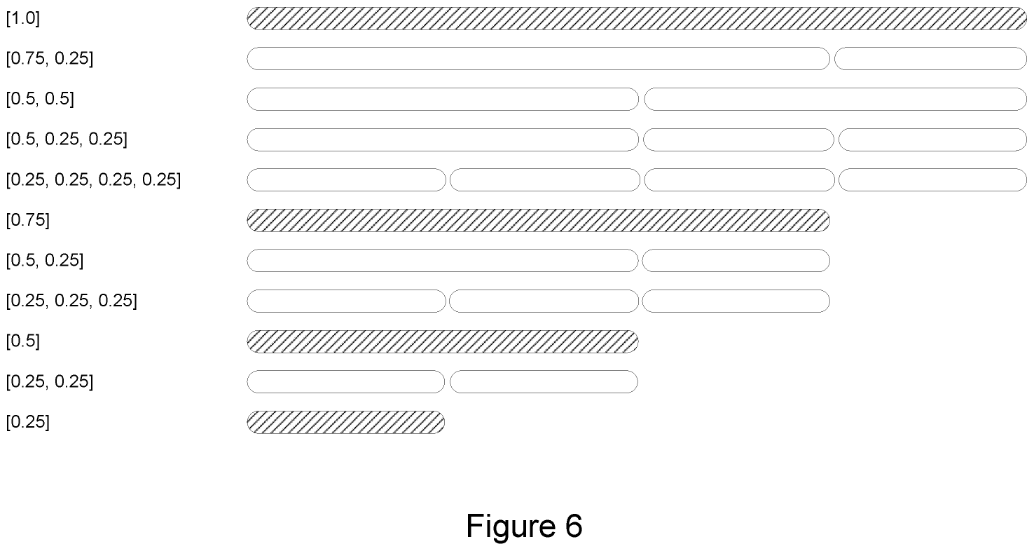

In the described embodiments we extend the slimmable idea by introducing various additional configurations, where the sub-models of different widths may be slimmed at different locations within the full network to enable the distribution of those sub-models on several devices. An example of possible ParaDiS framework configurations is given in FIG. 6. In contrast to the slimmable framework (FIG. 5), the widths are now replaced by lists of widths (FIG. 6). For example, configuration [0.5, 0.25, 0.25] means that it consists of 3 sub-models of widths 0.5, 0.25 and 0.25 that are consecutively extracted from the full model and are to be distributed in parallel on 3 devices.

All the configurations of ParaDiS framework are trained jointly and share their parameters (except for batch normalization statistics). As for the deployment, given a particular setting (characterized by number of devices and their current capacities), the most suitable configuration is selected and used for inference.

Let us recall again the advantages of this solution over the state-of-the-art approaches.
As compared to sequential model distribution strategies, the parallel distribution leads to much smaller processing latencies.
On the other hand, in contrast to training a separate model for each device setting, ParaDiS framework allows considerable gains in both memory (configurations share most of their parameters) and in training time (training jointly is usually much faster than training each individual configuration).
Additionally, training different configuration jointly and sharing the parameters makes the framework is flexible. This means that at inference time it is easy to go from one configuration to another. For example, to switch from configuration [0.5, 0.5] to configuration [0.5, 0.25] if the second device has less computational resources available.

The ParaDiS framework is presented in this section for an image classification task. However, the framework is more general and may be used for many other tasks for vertical applications (e.g., home surveillance, gaming, robotics/industry4.0).

Note also that ParaDiS is not just one particular CNN architecture, but a general framework applicable for flexible parallelization of various state-of-the-art CNNs. For example, within image classification task it can be used for ResNet, ImageNet-V1/V2, ShuffleNet-V1/V2, and many other CNNs. As such, in this section we do not specify which particular architecture is used, and we generally speak about ParaDiS network. This can be any flexibly distributable network trained using the proposed ParaDiS framework.

### ParaDiS Network Parameters Sharing

A ParaDiS network consists of a main network (e.g., MobileNet-V1) corresponding to the configuration [1.0] in FIG. 6 and of all other pre-defined configurations (e.g., as those represented in FIG. 6) that share their parameters with the main network, except for batch normalization statistics. Indeed, the batch normalization statistics are estimated independently for each configuration. However, since batch normalization statistics correspond usually to a very a very tiny part of all CNN parameters, this leads to a very small storage overhead.

### ParaDiS Network Deployment/Inference

Once a ParaDiS network is created and properly trained (e.g., as described below) it can be deployed following at least the following two scenarios. We assume that there are several devices that are available and that their availability and capacities (memory and processing resources) may vary over time.

### Deployment/Inference Scenario 1:

0. A complete copy of ParaDiS network is uploaded to each device.
1. The set of available devices is analyzed in terms of their current capacities.
2. A current ParaDiS network configuration is chosen to maximize the performance (under the given constraints).
3. Process next data point (image in our case):
   a. Send the image to each device.
   b. Execute in each device a sub-network corresponding to the current ParaDiS network configuration.
   c. Fuse the result.
4. Check availability of devices and their current capacities:
   a. If new devices have appeared, upload a complete copy of ParaDiS network to these devices
   b. If nothing has changed, go to step 4
   c. If something has changed: go to step 3

Scenario 1 is attractive since it fully benefits of the flexibility of ParaDiS network: instant adaptation to changing settings without a need of re-uploading any model (except for new devices). However, this is acceptable only when each device has enough memory to upload a complete copy of ParaDiS network on it.

When memory capacities of devices are more limited, the deployment scenario 2 might be more appropriate.

### Deployment/Inference Scenario 2:

1. The set of available devices is analyzed in terms of their current capacities.
2. A current ParaDiS network configuration is chosen to maximize the performance (under the given constraints).
3. A sub-network corresponding to the current ParaDiS network configuration is uploaded to each device accordingly.
4. Process next data point (image in our case):
   a. Send the image to each device.
   b. Execute in each device the ParaDiS network sub-network that was uploaded to it.
   c. Fuse the result.
5. Check availability of devices and their current capacities:
   a. If nothing has changed, go to step 4
   b. If something has changed: go to step 2

Scenario 2 is less attractive than scenario 1 since the ParaDiS network sub-networks need to be re-uploaded to the devices every time the devices setting changes. On the other hand, in contrast to scenario 1, scenario 2 is more optimal in terms of devices memory usage.

### Flowchart:

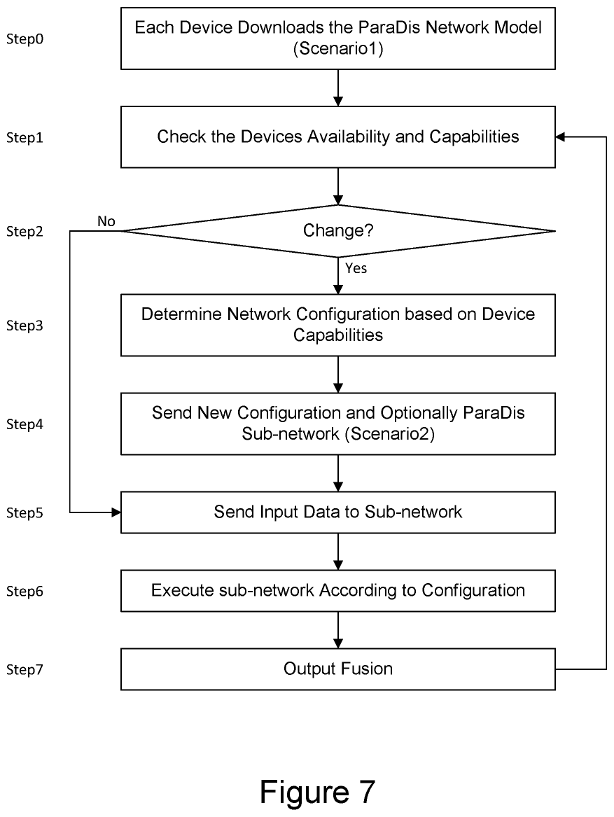

The flowchart below (FIG. 7) regroups the two deployment scenarios presented above. The function of the controller could reside in the cloud/edge server or in one of the devices. In the same way, the input generation and output fusion could be handled by one of the devices available, by the controller or by yet another device with limited computational power such as a camera (in which case the device handles only the input and output fusion but do not execute the sub-network).

### Description of the Steps:

Step0: In deployment scenario 1 (where the devices have enough memory to store a copy of the model), the controller uploads the model to each devices/each device downloads the complete model.
Step1: The controller checks the devices availability and capabilities (computational resources, battery level . . . )
Step2: The controller checks if there is a modification in the devices available or their capabilities.
   If modified, go to Step3.
   If not modified, go to Step5.
Step3: The controller determines the network configuration (sub-network to be run by each device) based on the reported capabilities of each device and the previous configuration (to ensure minimum change between consecutive runs).
Step4: The controller sends the new network configuration and for deployment scenario2 the necessary sub-network parameters/each device updates the network configuration (scenario1) or sub-network parameters (scenario2).
Step5: A device (this could be a device participating in the distributed inference or an external device) sends the input of the parallel sub-networks to the participating devices.
Step6: Each device executes the sub-network according to the received configuration sent by the controller.
Step7: Each device sends the output of its sub-network to the device or controller that will execute the output fusion.

### Communication Flowchart:

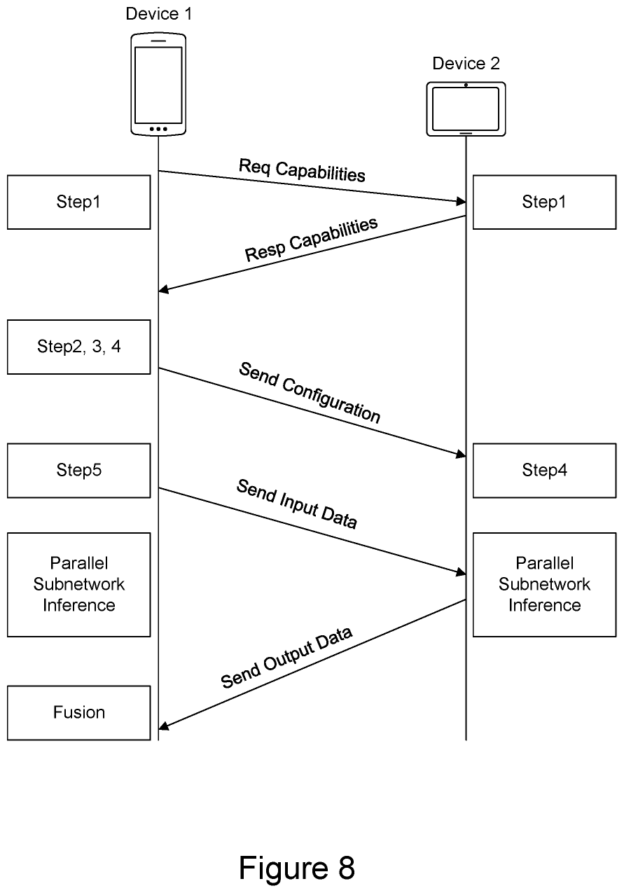

In FIG. 8, below, we present the message exchanged for a deployment with 2 devices where Device 1 is both a participant and handles the controller functions:

### ParaDiS Network Training

As for training ParaDiS network we propose to follow “sandwich rule” approach with in-place knowledge distillation (IPKD) proposed for Universally Slimmable Networks, though with several modifications and for different kind of configurations (in an earlier work, parallel CNN distribution is not considered at all).

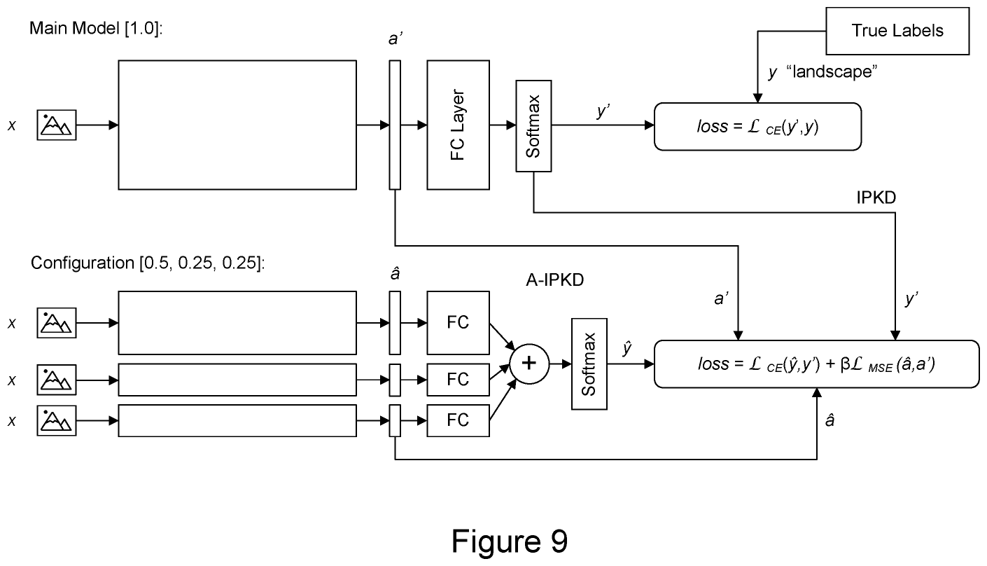

This training is based on the following ingredients:
1. “Sandwich rule” updates: For every mini batch only a few of configurations are updated. Those configurations include the main model [1.0], the smallest configuration (e.g., [0.25] in FIG. 6) and several (e.g., two) in-between configurations (see FIG. 6) selected randomly. In other words, the extreme configurations [1.0] and [0.25] are updated all the time, and others just from time to time. Forward and backward passes are computed for selected configurations to accumulate gradients, and finally one optimization step is done accordingly.
2. Main model [1.0] is trained based on true labels and using cross entropy loss

$${ℒ}_{CE} ( {y}^{′} , y ) = {\sum }_{c = 1}^{C} {y}_{c}^{′} log ( {y}_{c} )$$

where C is the number of classes, and y and y′ are C-dimentional hot vectors of true and predicted labels, respectively (see FIG. 9).
3. In-place knowledge distillation (IPKD): All other configurations are trained using IPKD loss

[symbol]

_{CE}(ŷ,y′)
where ŷ is predicted by the configuration and y′ is predicted by the main model. In other words, labels predicted by the main model are used instead of true labels (see FIG. 9).
4. Activations in-place knowledge distillation (A-IPKD): To better train the individual sub-models, we also introduce IPKD of filters activations before the last fully connected (FC) layer (see FIG. 9). This is achieved by adding the following Mean Squared Error (MSE) term to the loss:

$${βℒ}_{MSE} ( \hat{a} , {a}^{′} ) = β {‖ \hat{a} - {a}^{′} ‖}_{2}^{2}$$

where β is a positive constant, â is the vector of activations of the configuration and a′ is the corresponding vector of the main model.
5. Calibration phase: Once the training is finished, individual batch normalization statistics are computed for each configuration.

Overall training procedure may be summarized as follows (using some pseudo-Python/PyTorch notations):

Algorithm 1: Training ParaDiS network M

Require: Define list of configurations, e.g., as on Figure 7:

[[1.0],[0.75,0.25],...,[0.25]]

Require: Define n as number of sampled configurations per training

iteration, for example, n = 4.

| 1 | Initialize training settings of main shared network M. | |
|---|---|---|
| 2 | for t = 1,..., Titers do | |
| 3 | \| | Get next mini-batch of data x and label y. |
| 4 | \| | Clear gradients, optimizer.zerograd( ). |
| 5 | \| | Execute full-network, (y′,a′) = M(x,[1.0]). |
| 6 | \| | Compute loss, loss = [symbol] _{CE}(y′, y). |
| 7 | \| | Accumulate gradients, loss.backward( ). |
| 8 | \| | Stop gradients of y′ as label, y′ = y′.detach( ). |
| 9 | \| | Stop gradients of a′ as activation, a′= a′.detach( ). |
| 10 | \| | Randomly sample (n − 2) configurations, as conf samples. |
| 11 | \| | Add smallest configuration (e.g., [0.25]) to conf samples. |
| 12 | \| | for conf in conf samples do |

|_{——}

| | | |
|---|---|---|
| 13 | \| | Execute configuration conf, (ŷ,â) = M(x, conf ). |
| | \| | Compute loss, loss = [symbol] _{CE}(ŷ, y′) + β [symbol] _{MSE}(â, a′). |

|_{——}

| | |
|---|---|
| 14 | Accumulate gradients, loss.backward( ). |

| | |
|---|---|
| 16 | Update weights, optimizer.step( ). |

The described embodiments can be used in various Consumer Electronics devices (including smart TV, smart Camera, gateways and set-top boxes) for vertical applications (e.g. Home surveillance, gaming, robotics/Industry4.0) and also in Mobile devices (i.e. smartphones). The controller function can be integrated in the cloud or edge server or a CE/mobile device.

In scenario 1 (devices each have a copy of the model, no memory restriction):
The model is downloaded by all the devices that are using the ParaDis network.
Between 2 inferences or at regular interval, the devices will exchange information on their current capabilities
If the capability of one device changes, the controller will send a notification to this device (or possibly to all devices) and the configuration of the network will change.

In scenario 2 (devices have limited memory and cannot download the full model):
In addition to the exchange of capabilities, the controller will need to update the different devices with the parameters of the sub-networks of the current configuration.

In both scenario 1 and 2:
Between 2 inferences or at regular interval, the devices will exchange information on their current capabilities
When a different configuration is selected (i.e., when the devices capabilities change), the computational resources used by the sub-network in the different devices are also modified. This is also the case for the total inference time.
The input and output fusion should also be noticeable.

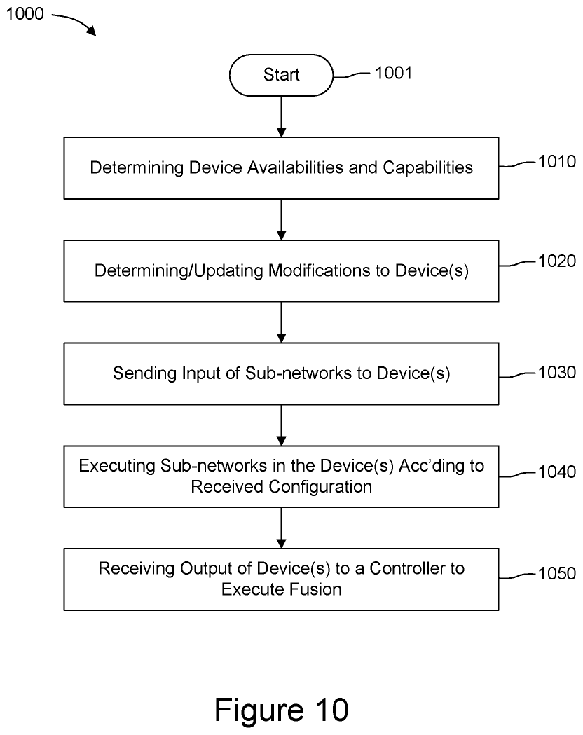

One embodiment of a method 1000 under the general aspects described here is shown in FIG. 10. The method commences at start block 1001 and control proceeds to block 1010 for determining availability and capabilities of the at least one device. Control proceeds from block 1010 to block 1020 for determining whether a modification is available in the at least one device or in capabilities of the at least one device, and if a modification is available, determining and sending an updated network configuration. Control proceeds from block 1020 to block 1030 for sending input of parallel sub-networks to the at least one device. Control proceeds from block 1030 to block 1040 for executing sub-networks in the at least one device according to a received configuration. Control proceeds from block 1040 to block 1050 for receiving output by the at least one device to a controller to execute fusion.

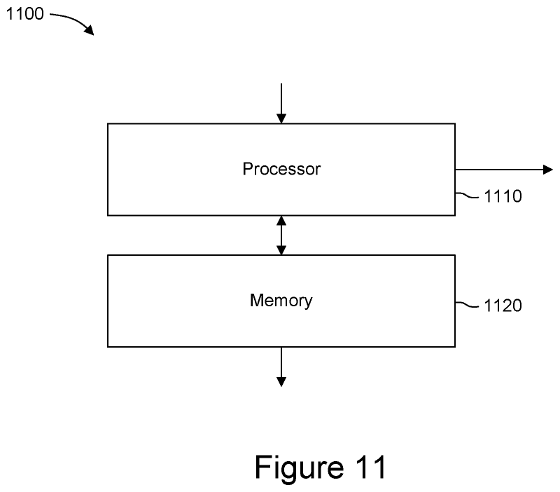

FIG. 11 shows one embodiment of an apparatus 1100 for implementing the general aspects described here, such as the embodiment of FIG. 10. The apparatus comprises Processor 1110 and can be interconnected to a memory 1120 through at least one port. Both Processor 1110 and memory 1120 can also have one or more additional interconnections to external connections.

Processor 1110 is also configured to either insert or receive information in a bitstream and, implementing any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

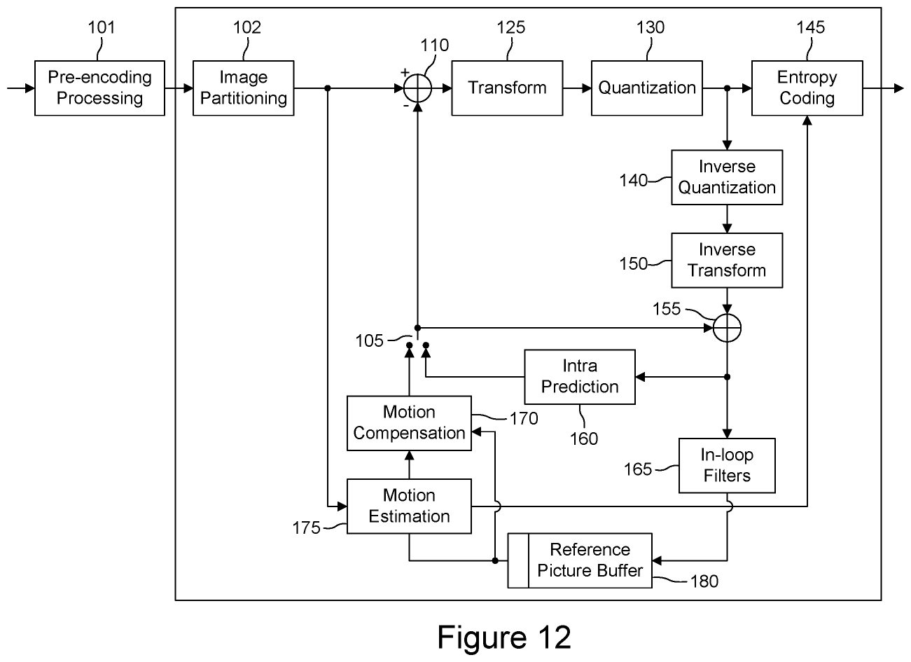

The aspects described and contemplated in this application can be implemented in many different forms. FIGS. 12, 13, and 14 provide some embodiments, but other embodiments are contemplated and the discussion of FIGS. 12, 13, and 14 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

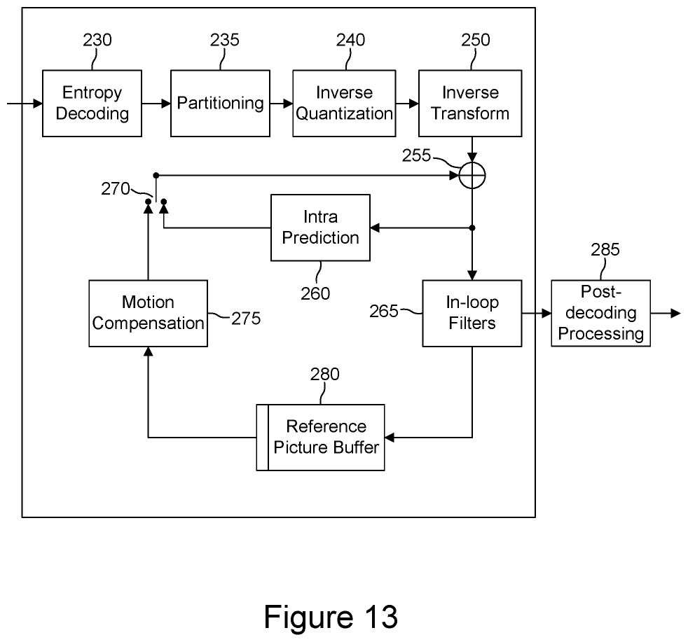

Various methods and other aspects described in this application can be used to modify modules, for example, the intra prediction, entropy coding, and/or decoding modules (160, 360, 145, 330), of a video encoder 100 and decoder 200 as shown in FIG. 12 and FIG. 13. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 12 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 13 illustrates a block diagram of a video decoder 200. In the decoder 200, a bitstream is decoded by the decoder elements as described below. Video decoder 200 generally performs a decoding pass reciprocal to the encoding pass as described in FIG. 12. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

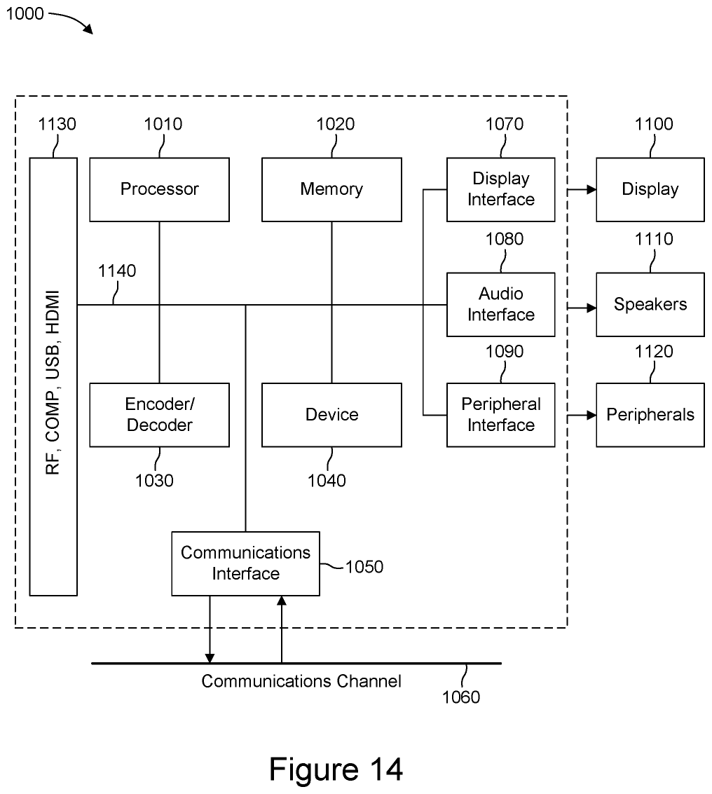

FIG. 14 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 14, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Embodiments may include one or more of the following features or entities, alone or in combination, across various different claim categories and types:
Performing distributed inference among a plurality of devices.
The above method whereby a convolutional neural network is parallelly distributed without retraining.
The above method wherein the network is adaptive.
The above method wherein adaptation is performed without re-training of parameters.
A bitstream or signal that includes one or more syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs in-loop filtering according to any of the embodiments described.
A TV, set-top box, cell phone, tablet, or other electronic device that performs in-loop filtering according to any of the embodiments described, and that displays (e.g. using a monitor, screen, or other type of display) a resulting image.
A TV, set-top box, cell phone, tablet, or other electronic device that tunes (e.g. using a tuner) a channel to receive a signal including an encoded image, and performs in-loop filtering according to any of the embodiments described.
A TV, set-top box, cell phone, tablet, or other electronic device that receives (e.g. using an antenna) a signal over the air that includes an encoded image, and performs in-loop filtering according to any of the embodiments described.

Various other generalized, as well as particularized, inventions and claims are also supported and contemplated throughout this description.

1. A method, comprising:
determining availability and capabilities of at least one device in a convolutional neural network;
determining whether a modification is available in the at least one device or in capabilities of the at least one device, and if a modification is available, determining and sending an updated or convolutional neural network configuration;
sending an input image of parallel sub-networks to the at least one device;
executing sub-networks to process the input image in the at least one device according to a received configuration; and,
receiving output by the at least one device to a controller to execute fusion of a processed image.

2. An apparatus, comprising:
a processor, configured to perform:
determining availability and capabilities of at least one device in a convolutional neural network;
determining whether a modification is available in the at least one device or in capabilities of the at least one device, and if a modification is available, determining and sending an updated convolutional neural network configuration;
sending an input image of parallel sub-networks to the at least one device;
executing sub-networks to process the input image in the at least one device according to a received configuration; and,
receiving output by the at least one device to a controller to execute fusion of a processed image.

3. The method of claim 1, further comprising uploading a neural network model to at least one device.

4. The method of claim, implemented for video encoding.

5. The method of claim 1, implemented for video decoding.

6. A device comprising:
an apparatus according to claim 2; and
at least one of (i) an antenna configured to receive a signal, the signal including the coding unit, (ii) a band limiter configured to limit the received signal to a band of frequencies that includes the coding unit, and (iii) a display configured to display an output representative of a coding unit.

7. A non-transitory computer readable medium containing data content generated according to the method of claim 1, for playback using a processor.

8. (canceled)

9. A computer program product comprising instructions which, when the program is executed by a computer, cause the computer to carry out the method of claim 3.

10. The apparatus of claim 2, further comprising uploading a neural network model to at least one device.

11. The apparatus of claim 2, implemented for video encoding.

12. The apparatus of claim 2, implemented for video decoding.
